(19) United States
(12) Patent Application Publication
(10) Pub. No.: US 2012/0196010 A1
(43) Pub. Date: Aug. 2, 2012

(54) Continuous Process for Making a Wheat Tortilla

(75) Inventors: Ximena Quintero Fuentes, Flower Mound, TX (US); Ponnattu Kurian Joseph, Irving, TX (US)

(73) Assignee: Frito-Lay North America, Inc., Plano, TX (US)

(21) Appl. No.: 13/016,558

(22) Filed: Jan. 28, 2011

(51) Int. Cl. A23P 1/00; A21B 1/22; A21B 1/00; A21D 13/00; A21B 2/00

(52) U.S. Cl. 426/243; 426/502; 426/560; 99/349; 392/416; 126/39 C; 219/391

(57) ABSTRACT

A continuous process for making a wheat tortilla or other similar products using a continuous pressing step that occurs during a continuous oven initial cooking step or immediately thereafter. Applicants' invention produces a final product with characteristics of a traditionally cooked flour tortilla using equipment that provides for significant increases in manufacturing throughput. The combination of the continuous oven with the concurrent, or relatively concurrent, pressing step substitutes for the hot pressing plates used in previous methods.

### BACKGROUND OF THE INVENTION

1. Technical Field

The present invention relates to a method for making a wheat flour tortilla and other products in a continuous sheeting operation. Specifically, the process involves lightly toasting or partially cooking a sheeted dough piece in an infrared or other high temperature oven while concurrently or very shortly thereafter pressing the dough piece in order to promote a tortilla texture in the final product.

2. Description of Related Art

Flour tortillas are traditionally made in a batch or semi-continuous process using a hot press that gives the tortilla its unique unleavened texture. In this traditional process a dough is first made by mixing primarily wheat flour with water and other minor ingredients. The dough is formed into individual dough balls. These dough balls are then pressed between two flat, hot plates.

To better understand the semi-continuous or batch method used in the traditional process reference can be made to FIG. 1. First wheat flour and water, in approximate amounts of two times the wheat flour than the water by weight, are mixed 102 with other minor ingredients, which can include an oil or an emulsifier. After the mixing step 102 the dough is separated into individual balls of dough in a forming step 104. These balls of raw dough are then each individually subjected to a pressing step 110 between two hot, flat surfaces or plates. The purpose of this pressing step 110 is to cook the dough without allowing for an expansion that would produce more of a pita bread like structure. The dough ball is typically held in this hot press during the pressing step 110 for between 15 and 30 seconds while the hot plates, traditionally called a comal, maintain a temperature of about 190° C. to about 250° C.

The moisture level of the dough made at the mixing step 102 is typically, in the traditional process, between 45% and 55% water by weight. The dough is cooked in the comal or between the hot plates until the moisture content is reduced to less than 35% by weight, or typically between about 20% by weight to 34% by weight. The tortilla is cooked once it achieves this reduced moisture level and the slightly puffed texture of a traditional flour tortilla.

This traditional or hot-plate method has been mimicked at the industrial level as is best explained by again referencing FIG. 1. Under the traditional process just described the pressing step 110 includes the energy necessary to cook the flour tortilla to its final condition. However, when this method has been used on an industrial scale, the pressing step 110 is reduced substantially in dwell time. Specifically, the dough ball is pressed just long enough to impart a thin capping layer on each side of the tortilla. These thin capping layers seal the tortilla to prevent water from escaping from the dough during further cooking. At the pressing step 110 during the industrial process the moisture level is only reduced by 2% or 3% by weight. Thereafter, the only partially cooked tortilla is subjected to an additional cooking step 114 in order to lower the moisture content of the tortilla further to provide for good shelf stability. Typically, the moisture level is reduced to below 30% by weight. Finally, the cooked flour tortilla is packaged during a packaging step 116.

Another method used in the industrial flour tortilla manufacturing process is referred to as the die-cut method. In this method an extruding device is used for shaping a sheet of wheat dough to a specific thickness. The sheet is thereafter cut, typically by a stamping disk, in order to produce a circular shape dough piece. The dough piece is then cooked at high temperature to form a capping layer. However, without the use of a physical press while simultaneously providing a convective heat to cook the tortilla, no industrial method has been found that is suitable to produce a flour tortilla with the characteristic texture of the flour tortilla made with the traditional hot-press method. Even including prior art hot press/plate methods, no method has been found that can produce a suitable flour tortilla while also maintaining the throughput typically expected with a sheeter equipped line.

Consequently, the need exist for a continuous process for the production of flour tortilla and other like products that avoids the use of a hot plate. Such process should be capable of throughput rates typical of sheeter lines and, preferably, use equipment which provides for a minimal plant footprint.

### SUMMARY OF THE INVENTION

In a preferred embodiment the invention mixes raw ingredients to produce a sheetable dough. In one embodiment, the dough is then sheeted to a set thickness and cut into shapes, such as a circular, flat tortilla shape. These dough pieces travel down a conveyor through a continuous oven, such as an infrared oven. Concurrent with the residence of the dough pieces in the continuous infrared oven, or very shortly after leaving such oven, the dough pieces are subjected to a pressing step by one or more pressing rollers during the conveyance. The thus cooked tortilla pieces are then subject to further processing steps, which can include a further cooking step. In an alternative embodiment, the partially-cooked dough pieces are cut to chip shape pieces prior to a finish cooking.

The invention provides for a continuous process that produces a flour tortilla that displays traditional flour tortilla characteristics comparable to those produced by the hot-plate method. Yet, such process provides for substantially increased throughput and minimal plant footprint.

### BRIEF DESCRIPTION OF THE DRAWINGS

The novel features believed characteristic of the invention are set forth in the appended claims. The invention itself, however, as well as a preferred embodiment, further objectives and advantages thereof, will be best understood by reference to the following detailed description of illustrative embodiments when read in conjunction with the accompanying drawings, wherein:

FIG. 1 is flowchart of a prior art method for making flour tortillas;

FIG. 2 is a flowchart illustrating one embodiment of Applicants' invention;

FIG. 3 is a schematic diagram of pressing rollers of one embodiment of the Applicants' invention; and

FIG. 4 is a schematic diagram of an alternative embodiment of Applicants' pressing rollers.

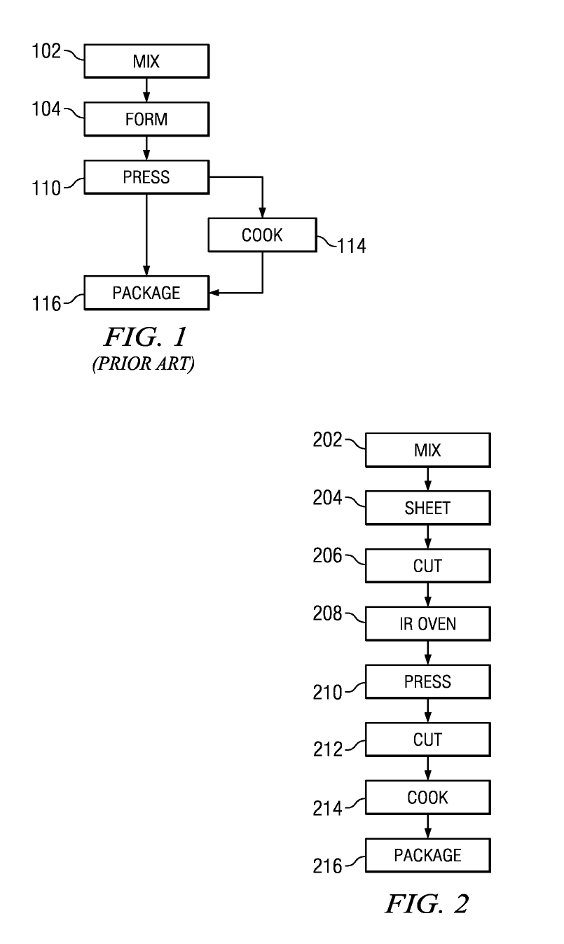

### DETAILED DESCRIPTION

Referring to FIG. 2, Applicants' process starts with a mixing step 202. In one embodiment Applicants used a Hobart legacy mixer on a setting of low for two minutes to mix the dry ingredients. Water was added thereafter, and the mixer was run for another two minutes at the low setting. Finally, oil was added and the mixer was run for an additional two minutes on the low setting. Table 1 shows ranges for the components of this admix by way of example. It should be noted, however, that Applicants' invention is suitable for any number of ingredient mixes with a wide variety of individual components, as long as the end product is a sheetable dough.

TABLE 1
Ingredients of Admix of Weight %

| Ingredients | Example Ranges |
|---|---|
| Flour | 61-63 |
| Water | 28-30 |
| Sunflower Oil | 7-8 |
| Sea Salt | 0-1 |
| Defatted lecithin | 0-2 |

Returning to FIG. 2, the admix is next routed to a sheeter for a sheeting step 204. Using the ingredients listed in Table 1 the sheeter was set with a nip height of 0.7 mm. This produced an actual sheet thickness of 1.6 mm.

After the sheeting step 204, the resulting sheeted dough, in one embodiment, is cut in a cutting step 206 into circular shapes, having a diameter of approximately 5.75 inches. The diameter of the cut circles can be changed significantly and still stay within the scope of Applicants' invention. Further, the piece may be cut in other shapes, such as squares, triangles, trapezoids, rectangles, and ovals, or even maintained as a continuous piece for later cuttings. In an alternative embodiment the sheeted dough is laminated, meaning folded successively to form two or more distinct dough layers stacked horizontally. Such lamination contributes to an internally stratified or flaky end product.

In either embodiment, the cut dough pieces then travel down a conveyor and pass through a continuous oven during a first cooking step 208 (shown as involving an infrared “IR” oven as a preferred embodiment). This cooking step 208 can be characterized as a partial cook or light toasting step.

The continuous oven used in Applicants invention is characterized as allowing product (dough pieces) to enter and exit the oven on a conveyer while exposing the product to high temperatures over a relatively short period of time, such as in excess of 400° F. for between 6 and 60 seconds, depending on the product thickness. One example of a suitable oven used by Applicants is a continuous conveyorized pita oven with gas burners set at 850° F. and 575° F. above and below the conveyors, respectively. Using such an oven with a conveyer speed set at to yield a product dwell time of 12.7 seconds in the 6 foot long oven was found suitable for the dough pieces described herein. Other acceptable continuous ovens include combination gas/electric ovens, infrared ovens, and high temperature electric ovens. The temperature and dwell time are determined by the thickness and moisture level of the dough pieces.

In one embodiment the dwell time in an infrared oven was approximately 5 seconds at a head temperature, said heads located about 10 cm above and below the conveyor, sufficient to result in an oven temperature of 450° F. The moisture level of the dough pieces is reduced very little by the infrared oven during this partial cooking step 208, and typically not more than 5% by weight of the moisture in the pieces is lost at this stage 208. In fact, less than 2% of the moisture in a preferred embodiment is lost during this first cooking step 208. The first cooking step 208 can be characterized by a light toasting of the outside layers of the top and the bottom of the dough piece. This light toasting 208 provides a capping layer or a partial barrier to the exhaustion of moisture during further cooking.

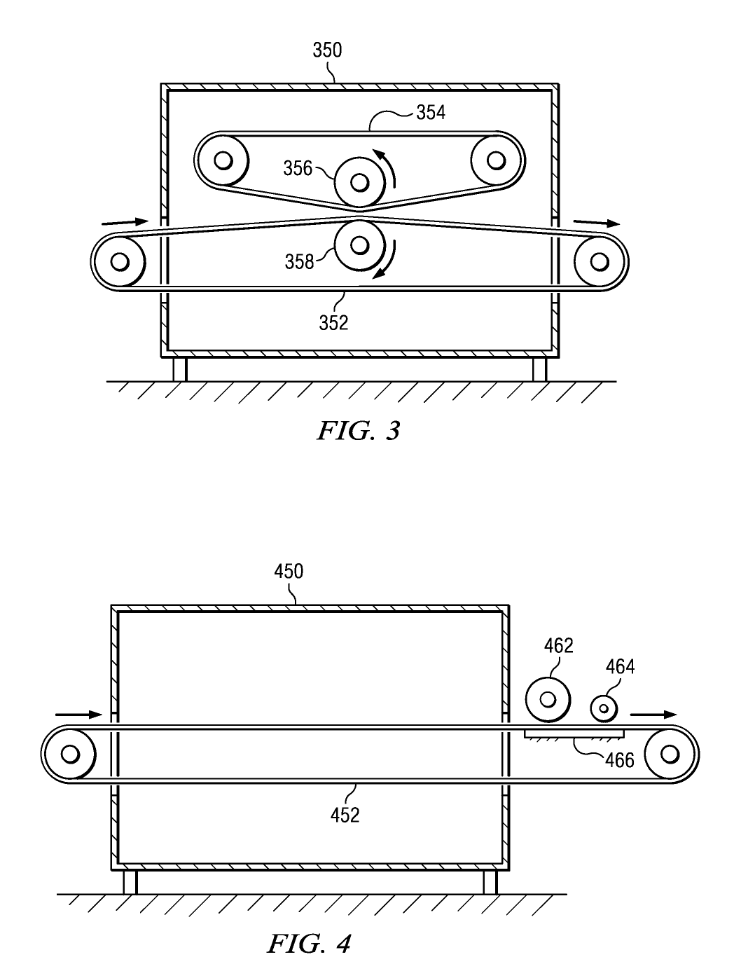

Concurrent with, or followed shortly thereafter, the first cooking step 208 in the continuous oven, Applicants' invention utilizes a pressing step 210. In the embodiment involving the pressing step 210 occurring concurrently with the first cooking step 208, this is accomplished by the use of pressing rollers located within the oven. This embodiment will be discussed further below with referenced to FIG. 3. In the embodiment involving pressing shortly after the first cooking step 208, this is accomplished by the use of pressing rollers located at the outlet of the oven, as will be discussed further below with reference to FIG. 4. In either event, the equipment used provides for a continuous pressing step, such that uncut sheeted dough can continuously pass through the equipment if desired.

Returning to FIG. 2, after the partial cooking and pressing steps 208, 210, the piece or sheet is sent to a final cooking step 214, whereby the moisture level by weight in the dough is reduced to below 35%, and preferably between 28% and 32% for the production of a traditional flour tortilla. In an alternative embodiment, this can be followed by a second pressing step as needed, depending on the desired end product characteristics.

In the alternative, the dough piece or continuous sheet is subjected to a cutting step 212 after the pressing step 210 that cuts the piece or sheet into smaller shapes, such as a tortilla chip shape, which are traditionally triangular. This cutting step 212, however, can also involve any number of shapes, including strips, squares, rectangles, trapezoidal shapes, ovals, and others. When cutting 212 occurs after the pressing step 210, the first cutting step 206 is optional, and the sheeted dough can be run continuously through to a first cooking step 208 and the pressing step 210. After this cutting step 212, these smaller pieces are then finished cooked in the final cooking step 214 to a moisture level by weight of below 10%, and preferably between 3% and 1%. This final cook can be by any means known in the art, including frying, baking with convective heat, infrared cooking, cooking by microwave, etc. This embodiment of Applicants' invention produces a chip or crisp product.

After the final cooking step 214 the flour tortillas or tortilla pieces are then subjected to further processing, such as seasoning, and finally packaged in a packaging step 216. Seasoning can also occur before the final cook step 214 and after the pressing 210 or cutting 212 steps.

As discussed above, one aspect of Applicants' invention is the pressing 210 of the dough piece either concurrent with the first cooking step 208 and/or immediately thereafter. Both of these conditions are met using a continuous pressing process, as distinguished from a stamping press used in the prior art. By combining a sheeter, one or more rolling cutters, a pass-through infrared or other continuous oven, and the rolling presses disclosed herein, Applicants' obtain throughput levels that are improvements upon prior art methods. Further, the equipment mentioned above accomplishes the improved throughput while maintaining a relative small plant footprint.

FIG. 3 illustrates one embodiment of Applicants' invention involving a press located within the interior of a continuous oven 350. Dough pieces enter the oven 350 on a bottom conveyor 352. At some point within the oven 350, and during the cooking process, the dough piece is pinched between at least one set of opposed rollers 356, 358. To assist the introduction of the dough piece between these two rollers 356, 358, they are located one each within an upper conveyor 354 and the lower conveyor 352 and are said to be “in association” with these conveyors 352, 354. In the alternative, the upper roller 356 can be used in isolation without the upper conveyor 354. Further, the lower roller 358 or the upper roller 356 can be replaced with a low pressure travelling press plate similar to the one illustrated with regards to FIG. 4 or overhead sandwiching conveyor (not shown). There can also be more than one set of opposed rollers 356, 358, or roller/press plate combinations located in series (not shown).

Passing the dough piece between the two opposed rollers 356, 358, or other embodiments of this concept, partially provides the functionality of mechanical pressing that a press plate offers in prior art processes. Yet, because of the continuous design of this aspect of Applicants' invention, the processing speed can be maintained at a constant. In fact, the dough sheet need not even be cut prior to entering Applicants' first oven 350 or can be cut using cutting rollers.

The distance between the two rollers 356, 358 is dependant on the specific dough characteristics, the height of the sheeted dough piece prior to entry into the oven 350, and the desired characteristics of the end product. However, a range of 0.5 mm to 5 mm is typical, with a preferable rage of 1.6 mm to 4.8 mm. A typical conveyor speed is between 60 fpm and 300 fpm. The conveyor speed used determines the dwell time of the piece in the oven 350 as well as the time required during the pressing between the opposed rollers 356, 358.

FIG. 4 illustrates a second embodiment of the pressing aspect of Applicants' invention. Again, the dough pieces enter a continuous oven 450 along a bottom conveyor 452. Immediately adjacent to the exit from the infrared oven 450 is located at least one pressing roller 462, 464, with two shown in FIG. 4. It should be understood that while FIG. 4 illustrates two pressing rollers 462, 464, that Applicants' invention can use one or more pressing rollers as well as one or more sets of opposed pressing rollers similar to those shown in FIG. 3. Also shown in FIG. 4 is a pressing plate 466, which is a solid piece against which the pressing rollers 462, 464 can press the dough piece as it passes below them.

The pressing rollers 462, 464 used in the embodiment illustrated in FIG. 4 should be as close as possible to the exit of the oven 450. Preferably no more than 10 seconds should elapse from the time that the dough piece first exits the oven 450 until it is subjected to a pressing step by the pressing rollers 462, 464. More preferably, this time should be less than 2 seconds. Most preferably, this time should be less than 1 second. Pressing this soon after the first cooking step helps set or cap the dough while it is still in an elevated temperature state.

Because the ovens 350, 450 shown in FIGS. 3 and 4 accommodate a conveyer 352, 452 that passes through the oven 350, 450, the oven is said to be “in communication” with the upstream sheeter (not shown). Thus, the dough sheeter is in communication with the continuous oven 350, 450. The continuous oven 350, 450 accommodates the continuous conveyor 352, 452 and, with the FIG. 3 embodiment, a dough pressing mechanism comprising the roller 356, 358, which are in association with the continuous conveyors 352, 354. Although not illustrated, it should be understood that such continuous oven 350, 450 can include multiple oven chambers.

It should also be noted that the sheeted dough is continuously conveyed after the sheeting step 204, meaning the dough proceeds without stopping through the remaining processing steps illustrated in FIG. 2 up to at least the final cooking step 214. This is referred to by Applicants as “continuously conveying” or the “continuous conveyance.”

While the invention has been particularly shown and described with reference to a preferred embodiment, it will be understood by those skilled in the art that various changes in form and detail may be made therein without departing from the spirit and scope of the invention.

What is claimed is:

1. A method for making a wheat based tortilla, said method comprising the steps of:
a) mixing wheat flour with water to form a dough
b) sheeting said dough;
c) continuously conveying the sheeted dough of step b); and
d) cooking and pressing said dough during the continuous conveyance of step c), wherein said cooking occurs in a continuous oven, and further wherein said pressing occurs concurrently with said cooking to less than 2 seconds after the completion of said cooking.

2. The method of claim 1 further comprising:
e) further cooking the pressed piece of step d) after the completion of step d).

3. The method of claim 2 wherein the pressed piece of step d) is cut into a plurality of pieces prior to the cooking of step e).

4. The method of claim 1 wherein the cooking of step d) comprises an oven temperature of at least 400° F., a dwell time in the oven of between 6 and 60 seconds.

5. The method of claim 1 wherein the sheeted dough of step b) is cut into dough pieces prior to the cooking of step d).

6. The method of claim 1 wherein the pressing of step d) occurs concurrently with the cooking of step d).

7. The method of claim 1 wherein the cooking of step d) results in a moisture loss by weight in the dough of less than 2%.

8. The method of claim 1 wherein the sheeting of step b) comprises lamination.

9. The method of claim 1 wherein the oven is an infrared oven.

10. The method of claim 1 wherein the oven is a gas oven.

11. The wheat based tortilla made by the method of claim 1.

12. A method for making a food piece, said method comprising:
a) forming a dough;
b) sheeting said dough;
c) partially cooking said dough in a continuous oven; and
d) pressing said dough from concurrent with said partial cooking step c) to less than 2 seconds thereafter, thereby forming a capping layer on the partially cooked and sheeted dough.

13. The method of claim 12 further comprising:
e) finish cooking after step d) to a moisture level by weight of less than 35%.

14. The method of claim 12 wherein the partial cooking of step c) comprises a dwell time in the oven of between 6 and 60 seconds at a temperature of at least 400° F., and results in a moisture loss by weight in the dough of less than 2%.

15. The method of claim 12 wherein the pressing of step d) occurs concurrent with the partial cooking of step c) and within said continuous oven.

16. The method of claim 12 wherein the dough is cut into pieces after the sheeting of step b).

17. The method of claim 12 wherein said oven is an infrared oven.

18. The food piece made by the method of claim 12.

19. An apparatus for making a food piece, said apparatus comprising:
a dough sheeter in communication with a continuous oven by way of a continuous conveyer, wherein said oven accommodates said continuous conveyer within the oven, and further wherein said oven comprises heating elements both above and below said continuous conveyer and a dough pressing mechanism within the oven and in association with said continuous conveyer.

20. The apparatus of claim 19 wherein said pressing mechanism comprises a pressing roller.

21. The apparatus of claim 20 wherein said pressing mechanism comprises a low pressure travelling press plate.

22. The apparatus of claim 20 wherein said pressing mechanism comprises an overhead sandwiching conveyor.

23. The apparatus of claim 19 wherein the oven is an infrared oven.

24. The apparatus of claim 19 wherein the oven is a gas oven.

25. The apparatus of claim 19 wherein the oven is an electric oven.
